(19) United States
(12) Patent Application Publication
(10) Pub. No.: US 2005/0247673 A1
(43) Pub. Date: Nov. 10, 2005

(54) Confinement of fluids on surfaces

(75) Inventors: Emmanuel Delamarche, Thalwil (CH); David Juncker, Zurich (CH); Heinz Schmid, Waedenswil (CH)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 10/841,390

(22) Filed: May 7, 2004

(51) Int. Cl. B44C 1/22; C23F 1/00

(52) U.S. Cl. 216/83; 216/88; 216/90; 156/345.11

(57) ABSTRACT

The invention is directed to a device for applying a fluid to a surface, the device comprising a first conduit for directing a flow of a first fluid towards the surface and a second conduit for directing a flow of a second fluid away from the surface, the first conduit being arranged relative to the second conduit such that in operation of the device the second fluid comprises substantially the first fluid, and wherein said first conduit comprises a first aperture and the second conduit comprises a second aperture, the first aperture arranged at a distance from the second aperture.

### FIELD OF THE INVENTION

The present invention generally relates to confinement of fluids on surfaces and particularly relates to methods and apparatus for applying and confining fluids to surface areas. Even more particularly the invention relates to locally processing a surface for both additive and subtractive patterning of materials while the surface is immersed in a fluid.

### BACKGROUND OF THE INVENTION

There are many applications in which it is desirable to apply a fluid to a surface. An example of such an application is in patterning or other processing of surfaces. Patterning and processing of surfaces with fluids is becoming increasingly important in a range of fields, including chemistry, biology, biotechnology, materials science, electronics, and optics. Patterning a surface by applying a fluid to the surface typically involves confinement of the fluid to defined regions of the surface.

A surface is typically wettable by a fluid if the contact angle between a drop of the fluid and the surface is less than 90 degrees. A channel for carrying a fluid is typically wettable if the channel exerts a negative pressure on the fluid when partially filled. Such a negative pressure promotes filling of the channel by the fluid. In a channel having a homogeneous surface, a negative pressure arises if the contact angle between the fluid and the surface is less than 90 degrees. A surface is typically regarded as being more wettable if the contact angle between the surface and the fluid is smaller, and less wettable if the contact angle between the surface and the fluid is higher.

One conventional surface patterning technique is lithography. In lithography, a mask is usually applied to a surface to be patterned. Apertures are formed in the mask to define regions of the surface to be exposed for treatment. Areas of the surface remaining covered by the mask are protected from treatment. The mask is typically formed from a patterned layer of resist material. The surface carrying the mask may then be immersed in a bath of chemical agents for treatment of the exposed regions. Lithography is a relatively expensive process to perform, involving multiple steps, expensive instruments and laboratory facilities with controlled environments. With the possible exception of in situ synthesis of short deoxyribonucleic acid (DNA) strands, lithography is generally unsuitable for handling and patterning biomolecules on surfaces. Lithography is also unsuitable for simultaneously processing surfaces with different chemicals in parallel, as described by Whitesides, Annu. Rev. Biomed. 3 (2001), 335-373. There can be incompatibility between different process steps or chemicals used in lithography and between various surface layers processed by lithography.

Another conventional surface patterning technique is drop delivery. Drop delivery systems, such as pin spotting systems, ink jet systems, and the like, typically project a relatively small volume of fluid onto a specific location on a surface. See, M. Shena, “Microarray Biochip Technology,” Eaton Publishing (2000). However, these systems have limited resolution due to spreading of dispensed drops on the surface. Additionally, the quality of patterns formed by such systems is limited by drying of the delivered fluid, as is described by J. T. Smith, Spreading Diagrams for the Optimization of Quill Pin Printed Microarray Density, 18 LANGMUIR 6289-293 (2002). Further, these systems are generally not useful for dissolving or extracting materials from a surface, do not facilitate a flow of fluid over a surface and are not suited to process a surface sequentially with more than one fluid.

PCT WO 01/63241 A2 describes a surface patterning technique involving use of a device having a channel with a discharge aperture. A matching pillar is engaged with the discharge aperture to promote deposition of molecules on a top surface of the pillar. However, it is not possible to vary patterning conditions for different pillars individually. Exposure of the pillar surface to the fluid should be long enough to allow reagents to reach the surface by diffusion. The method also requires a surface with pillars matching the aperture. Precise alignment of the device with the pillars before engagement is required. Spacing between the discharge aperture and the pillars needs external control. The pillars cannot be moved on the surface to draw lines.

Another conventional surface patterning technique involves application of a microfluidic device to a surface. An example of such a device is described in U.S. Pat. No. 6,089,853 issued to Biebuyck et al. (hereinafter “Biebuyck”). The microfluidic device can establish a flow of fluid over a surface. The flow can be created via capillary action in the device. The device can be used to treat a surface with different fluids in parallel. However, the device must be sealed to the surface to be treated to confine the fluid(s) to the region(s) of the surface to be treated. Confinement of the fluid(s) allows for the formation of patterns with relatively high contrast and resolution. High contrast and resolution are desirable qualities when biomolecules are patterned on a surface for biological screening and diagnostic purposes.

The device is placed on the surface to be treated and sealed around the processing regions before being filled with treatment fluid. However, if the flow is created by capillary action, several notable disadvantages result. First, service ports in the device must be filled with treatment fluid for each patterning operation. Also, only one fluid can be delivered to each channel in the device and cannot be flushed out of the channels before separation of the device from the surface. Further, the fluid tends to spread away from the regions of the surface to be treated during removal of the device from the surface. Therefore, the device is not suitable for processing a surface sequentially with several fluids.

If the flow is created by external actuation, such as by pressurization, electric fields, or the like, several other notable disadvantages result. For example, an individual connection from the actuator must be made to each channel in the device. These connections, e.g., to peripheral equipment, limit the density of channels that can be integrated into the device and addressed individually. Pumping, valving and control complexity increase as the number of channels increases. External connections create dead volume between the device and external actuators because of the intervening conduits.

Another microfluidic device for localized processing of a surface is described in IBM Technical Disclosure Bulletin reference RD n446, Article 165, Page 1046. The device is similar to that described in Biebuyck. It permits several fluids to be flushed in sequence over the same surface area without requiring separation of the device from the surface. Such a device is thus useful for chemical and biological reactions involving the sequential delivery of several fluids. However, the device must be sealed around the surface to be treated before filling. Further, the fluids cannot be filled prior to the device being applied to the surface. Each additional step requires supplementary filling of the relevant fluid. Further, the lines in the device need to be prestructured via lithography and cannot be readjusted subsequently.

Another conventional device for confining fluids to a predefined pattern between a top and bottom surface without involving a seal is described in European Patent 0 075 605. This device is useful for performing optical analysis of the confined fluid. However, the device requires predefined topographical or chemical patterns on both the top and bottom surfaces. Also, the device, having no inlet or outlet ports, is not suitable for the transport of fluids.

Another device for guiding fluids along a predetermined path is described in WO 99/56878. This device can flow several fluids simultaneously over a surface without involving a seal to confine the fluids. However, separation gaps between the paths have to be capillary inactive. This limits path sizes to greater than one millimeter (mm). Otherwise, meniscus pressures produce uncontrolled spreading of the fluids. Further, the fluid is not retained after separation and can instead spread over the surface, fluid delivery requires an external connection to each path and cumbersome peripheral flow control devices are required.

Yet another method for guiding fluid along a surface without involving a seal is described in B. Zhao et al., Surface-Directed Liquid Flow Inside Microchannels, 291 SCIENCE 1023-26 (2001). In this method, a surface is patterned with a wettability pattern. Specifically, two wettable patterns mirroring each other are defined on otherwise non-wettable top and bottom surfaces. This produces “virtual” channels without lateral walls, that can have a micrometer width. However, this method requires wettability patterns on both the top and bottom surfaces. In other words, the path for the flow of fluid must be predetermined using lithography, which is expensive and lacks flexibility. Furthermore, subsequent readjustment of the flow paths cannot be performed.

Further, the contrast in wettability between the two patterns needs to be very high, both non-wettable areas are required on both the top and bottom surfaces and highly wettable areas are required within the virtual channel. The two patterns have to match each other exactly in shape and alignment. Capillary action can be used to fill the channels, but the fluid cannot be removed or exchanged. This method is also susceptible to uncontrolled spreading of fluid because it is relatively difficult to produce sufficiently non-wettable surfaces.

A double pipette system might be employed for local controlled drug infusion. See for example, O. Feinerman, A Picoliter “Fountain Pen” Using Co-Axial Dual Pipettes, 127 JOURNAL OF NEUROSCIENCE METHODS 75-84 (2003). Namely, two concentric pipettes can be manipulated separately and pressurized independently by a designated double holder. The inner pipette is loaded with a desirable solution, and functions as a source, while the outer pipette serves as a sink. This configuration provides for a flow of solution between the two pipettes that protrudes only a small distance into the surrounding fluid and does not diffuse away. However, without moving the pipette the infusion only occurs only briefly and does not allow for the creation of a two-dimensional pattern.

In WO 01/49414 a dual capillary system is described that can be used to provide a resolubilizing fluid onto a surface of a substrate. A second capillary element is then used to draw the material from the surface of the substrate into the analysis channel of a microfluidic device. The capillaries are disposed adjacent to one another such that fluid is delivered from one capillary and drawn up into, e.g., sampled by, the other capillary without moving the microfluidic device or the substrate. Fluid is expelled from the fluid delivery capillary onto a sample material surface whereupon the sample material is at least partially resolubilized in the expelled fluid. A portion of the fluid on the substrate with the resolubilized sample material is then drawn into the analysis channel.

This system is designed to have the smallest distance possible between the capillaries such that the resolubilized sample material in the expelled fluid is received close to the fluid delivery capillary. The dual capillary system is not be moved over the sample surface during either delivery or sampling of the fluid. For this resolubilizing technique to function properly, there is to be some delay between delivery and sampling of the fluid. Further, sampling comprises drawing only a portion of the resolubilized material into the sampling capillary.

Therefore, it would be desirable to provide a technique for confining a fluid on a surface in a manner that allows the technique to be used to create two-dimensional patterns.

### SUMMARY OF THE INVENTION

According to a first aspect of the present invention, a device is provided for applying a fluid to a surface, also referred to as fluid pattern creator. The device comprises a first conduit for directing a flow of a first fluid towards a surface and a second conduit for directing a flow of a second fluid away from said surface. The first conduit is arranged relative to the second conduit such that in operation the second fluid comprises substantially the first fluid, and wherein the first conduit has a first aperture that is arranged at a distance from a second aperture of the second conduit. The first aperture is also referred to as discharge aperture, the second aperture is also referred to as aspirator aperture.

This device allows for the hydrodynamical confinement of the flow of a processing fluid between the discharge aperture, the aspirator aperture and a surface. Thereby a pattern can be created that corresponds to the flow path of the first fluid from the first conduit towards the second conduit. This technique is feasible even at micrometer resolution. This fluid pattern creator can also be used to confine and transport the first fluid over a surface that is immersed in the same or a different fluid, and can find application in surface and/or particle treatment/patterning for, e.g., microelectronics, optics, biology and biochemistry.

In a preferred embodiment, the fluid pattern creator may comprise a first fluid container for the first fluid and/or a second fluid container for the second fluid. Having a first fluid container and/or a second fluid container makes the fluid pattern creator independent from a remote fluid container, allowing the fluid pattern creator to be used in a more mobile manner.

In another preferred embodiment, the fluid pattern creator may further comprise a first flow controller for controlling a first flowrate or a first pressure of the first fluid and/or a second flow controller for controlling a second flowrate or a second pressure of the second fluid. The flow controller(s) can be used to control fluid flow, for example, to increase the amount of fluid per unit time that comes in contact with the surface, or to reduce the amount of fluid, other than the first fluid, that is contained in the second fluid.

The fluid pattern creator may preferably be set up in such a way that the first and second pressures are tuned to draw the first fluid towards the second aperture. Drawing the first fluid towards the second aperture increases the precision of the pattern created.

If the fluid pattern creator comprises a filter for regenerating the first fluid from the second fluid, the resulting first fluid can be reused for patterning, thus reducing the amount of wasted fluid. In this exemplary embodiment, a container for the first fluid can be smaller, since it needs to store a lesser volume of first fluid.

If the conduits are arranged at an applicator head the head may be positionable near the surface via head controllers, allowing more flexibility in handling devices with a surface to be patterned. In particular the fluid pattern creator could comprise a means, e.g., drive, for moving the applicator head relative to the surface. Being able to move the applicator head allows for easier positioning during creation of a desired pattern. Namely, it allows for movement of the applicator head during patterning, allowing for the creation of a larger variety of patterns.

If at least one of the apertures of the conduits is arranged in a recess of the applicator head, the flow of the fluid can be better controlled and decoupled from an environmental fluid. In a preferred embodiment, the first and the second aperture are arranged in the recess, serving as a flow path. In this embodiment, the flow path is not straight, e.g., curved. The form of the recess shapes the form of the flow path. When the flow path is not straight, a larger variety of patterns can be obtained without active flow-path-shaping means.

If the first aperture and the second aperture are arranged at a substantially identical distance from the surface, the flow of the first fluid towards the second aperture (i.e., from the first aperture) will be homogeneous, thereby allowing for an accurate determination of an amount of the first fluid coming into contact with the surface. The ability to accurately determine this amount is beneficial for assessing chemical interaction between the first fluid and the surface.

In an exemplary embodiment, a third conduit is arranged for directing the flow of a third fluid in such a way that the flow of the third fluid influences the flow direction of the first fluid. The third fluid can be selected to be an influencer, acting as an active forming means for the flow path, and/or to have a predetermined reactive characteristic, allowing the third fluid to become a part of the patterning process. For instance the third fluid can react with the first fluid, rendering the first fluid weaker or stronger, and thus changing the intensity of reaction and the pattern that is eventually created. The third fluid can also react with the surface to modify the pattern created by the other fluid(s).

The fluid pattern creator preferably comprises a distance element for determining the distance between the apertures and the surface. This distance element provides an efficient means to ensure that the distance between the apertures and the surface is kept constant. Maintaining a constant distance between the apertures and the surface results in a more predictable pattern.

If the fluid pattern creator comprises a unitary construction, e.g., manufactured from a single piece of material, the fluid pattern creator is both robust and more easily produced. At the same time, mechanical tolerances are not a critical issue, the resulting fluid pattern creator exhibits a higher degree of precision and alignment that is achievable. Aligrunent is a critical issue to create precise patterns on a surface.

In an exemplary embodiment, the first pressure is tuned such that the first fluid is retained in the first fluid container when the first aperture is remote from the surface. When the first aperture is moved to be proximal to the surface, pressure may be varied, e.g., applied, to initiate flow of the first fluid out of the first aperture and onto the surface. When the device is withdrawn from the surface, the first pressure may then again be tuned to draw back excessive fluid from the surface. Further, there may be a plurality of first fluid containers, each coupled to the first aperture, wherein the pressure for the first fluid in each of the plurality of first fluid containers is controlled, in parallel or individually.

The first or second pressure may be generated by external pumps, such as syringe pumps or peristaltic pumps, by integrated pumps, such as microfabricated pumps, by electro-kinetic pumping, by capillary-force based pumping, by other pumping means or by other means of pressurization. Further, valves may be provided for controlling the flowrate of the first or second fluid. Such valves may be located within external connections, in the fluid container, in the connections between the fluid container and the aperture or in the aperture. Such valves may be closed or opened on demand.

The present device, as described herein, may be part of a fluidic network. In such a fluidic network, there may be a feedback system for measuring the network pressure, for example, the pressure at the apertures and/or at the fluid containers. Alternatively, feedback may be provided based on the volume of fluid pumped. The feedback facilitates fluid flow control to avoid undesired spreading of fluid on the surface. When a plurality of fluid containers are present, each coupled to an aperture, pressure may be controlled in each fluid container, either in parallel or individually. Further, one or more valves may control the flow for each fluid container, either in parallel or individually (e.g., through use of a flow controller).

The flow controller may apply a pressure for retaining the fluid when the aperture is remote from the surface. The flow controller may also comprise a capillary network for applying pressure to the fluid. This capillary network may comprise one or more parallel capillary members, a mesh, a porous material and a fibrous material. There may be a plurality of fluid containers each coupled to an aperture. The pressures applied may be such that the fluid is drawn towards the fluid containers in response to withdrawal of the aperture from the surface. There may be a plurality of first and second fluid containers, each coupled to the aperture, wherein the pressure is controlled in each fluid container, either in parallel or individually.

The pressure for the first fluid container may be regulated such that the first fluid is retained in the first aperture when the flow path is remote from the surface. Pressure for the second fluid container may also be regulated such that the difference between the first and second pressures is oriented to promote flow of the first fluid from the first fluid container to the second fluid container, via the flow path, when the flow path is located proximal to the surface (the first fluid in the device contacting the surface). The first and second pressures can further be regulated such that excessive fluid is drawn towards at least the second fluid container in response to withdrawal of the flow path from the surface. There may be a plurality of first fluid containers each coupled to the flow path. Similarly, there may be a plurality of second fluid containers each coupled to the flow path.

As described above, the pressure in the first and second aperture may be generated by, e.g., external pumps. A feedback system may be provided that measures the pressure within the system, for example at the first and second aperture and/or at the first and second fluid container. The feedback system may be based on the volume of fluid pumped in the first and second fluid container. Employing this feedback system can facilitate control of the fluid flow and prevention of undesired spreading of fluid on the surface. There may be a plurality of first and second fluid containers each coupled to first and second apertures, where pressure is controlled in each of the first and second apertures, either in parallel or individually. Further, there may be one or more valves, controlling flow for each of the first and second apertures either in parallel or individually. There also may be a plurality of first fluid containers each coupled to the flow path and/or a plurality of second fluid containers each coupled to the flow path.

In an exemplary embodiment of the present invention, the first flow controller applies a first pressure for retaining the fluid when the flow path is remote from the surface. The second flow controller applies a second pressure to the second fluid such that the difference between the first and second pressures is oriented to promote flow of the first fluid from the first fluid container to the second fluid container via the flow path, in response to the flow path being located proximal to the surface and the fluid in the device contacting the surface. Many other applications of the present invention are possible.

As mentioned above, the device may comprise a unitary construction, and may be formed from materials that include, but are not limited to, elastomer, silicon, SU-8, photoresist, thermoplastic, ceramic, metal, and combinations comprising at least one of the foregoing materials. Alternatively, the device may comprise a layered construction, with each layer formed from materials that include, but are not limited to, glass, polymer, silicon, SU-8, photoresist, thermoplastic, metal, ceramics and combinations comprising at least one of the foregoing materials.

As mentioned above, the present devices are particularly useful for transporting a first fluid from a fluid container, well, reservoir, or similar fluid container, to a surface, and to confine the first fluid on the surface without the need for a physical seal between the device and the surface. Accordingly, each aperture of the device may be defined by and comprise non-sealing materials, including, but not limited to, silicon. The non-contact operation of the present device prevents contamination and/or damage to the surface being treated and/or to the device.

The present treatment techniques are applicable to surfaces having a wide range of different properties and wettability. The present device permits addition of a flow of first fluid, thus preventing depletion of material adsorbed to the surface treated. Homogeneous patterns of, for example, biomolecules may be thereby produced. When the present device is traced over the surface to be treated, the lines produced are smoother and smaller than those attained using conventional techniques, such as ink jet printing. For example, if the amount of the first fluid deposited is relatively small, there is little if any no spreading, quick drying and no excessive accumulation of material on the surface.

According to the present techniques, the concentration of deposited materials may be varied as the device is drawn over the surface treated. A range of gradients in concentration of deposited materials may thus be produced. Therefore, such a device is useful for both additive and subtractive patterning of materials onto a surface. Further, a series of such devices may be drawn over a surface in sequence. Each aperture of such a series of devices may contain a different one of a potential group of reagents for collectively implementing a chain reaction on the surface.

According to the teachings of the present invention, the device(s) can be pre-filled with processing fluids for subsequent repetitive application and surface removal during processing. Surface processing can be repeated multiple times using the same device without refilling (which can delay the process). The present device can also be swiftly mass-produced via conventional microfabrication techniques. In typical applications, the present device can be placed at an arbitrary location on a surface and process parameters can be controlled via dimensions and contact time. Arrays of such devices are relatively easy to fabricate.

The present devices are suitable for treating curved surfaces, such as beads or cylinders, inhomogeneous surfaces, surface with variable wettability, corrugated or otherwise roughened surfaces and the like. Further, the present device may be employed to deposit biomolecules in selected regions of a surface, e.g., to make bio-arrays, thus facilitating mass fabrication of bio-chips. The present device may also be employed in subjecting selected areas of a surface to other processes, including, but not limited to, processes for repairing pattern defects on a surface, etching specific areas of a surface, depositing metal on a surface, localizing an electrochemical reactions on a surface, depositing catalytic particles for electroless deposition of metals, deposition glass or latex beads or other particles on a surface, passivating specific areas of a surface, patterning proteins, deoxyribonucleic acid (DNA), cells, or other biological entities on a surface, making assays and staining cells.

The present device may be operated facing upwardly towards a downward facing surface, especially when the dimensions of the device are chosen to be small, such that forces in the fluid interface exceed inertial forces. In general, gravity has a limited effect on the device such that use of the device in reduced gravity environments is possible.

In one aspect of the present invention, a two aperture applicator head is located proximal to the surface. A first fluid is supplied to the surface via the applicator head. The applicator head is then retracted from the surface.

During supplying the first fluid, the first fluid flows from the first fluid container to the second fluid container via the flow path. The flow of the first fluid from the first fluid container to the second fluid container may be varied during the supply of the first fluid to the surface. Prior to retracting the applicator head, the applicator head may be moved relative to the surface, with the first fluid in one or more of the apertures contacting the surface.

The applicator head may be oriented relative to the surface such that traces of the fluid produced as the applicator head is moved relative to the surface remain separate, or alternatively, overlap. Prior to locating the applicator head proximal to the surface, the same fluid may be loaded into each of the fluid containers. Alternatively, one or more different fluids may be loaded into one or more of the fluid containers.

Further disclosed herein is a method for applying a fluid to a surface comprising the following steps. An array of applicator heads is located proximal to the surface. A first fluid is supplied to the surface via the array. In each applicator head of the array, the first fluid is flowed from the first fluid container to the second fluid container via a flow path. The array is moved relative to the surface with the first fluid in each aperture contacting the surface. The array is then retracted from the surface.

In at least one applicator head of the array, the flow of the first fluid from the first fluid container to the second fluid container may be varied during the supply of the first fluid to the surface. The array may be oriented relative to the surface in a way such that traces of the flows of first fluid produced as the array is moved relative to the surface remain separate, or alternatively, overlap. Similar or different first fluids may be loaded into each applicator head of the array.

In one embodiment of the present invention, an applicator head is brought close to a surface so as to contact the surface with the fluid in an area of micrometer dimensions defined by the geometry of the aperture. The applicator head is then removed from the surface. Prior to the removal of the applicator head, the surface may be moved laterally relative to the applicator head with the first fluid in the applicator head remaining in contact within the surface so that the first fluid is traced across the surface. Alternatively, the tracing may be performed using the applicator head and having the first fluid flowing between the apertures as the applicator head is traced is over of the surface.

A more complete understanding of the present invention, as well as further features and advantages of the present invention, will be obtained by reference to the following detailed description and drawings.

### BRIEF DESCRIPTION OF THE DRAWINGS

FIG. 1 is a cross-sectional side view/functional diagram of a fluid applicator with a concentrical arrangement of conduits;

FIG. 2a is a cross-sectional view of an applicator head with a first conduit arranged at a distance from a second conduit;

FIG. 2b is a plan view of the bottom surface of the applicator head shown in FIG. 2a;

FIG. 3 is a plan view of the bottom surface of an applicator head with more than two conduits;

FIG. 4 is a cross-sectional view/downside view of an applicator head with two apertures within an arc-shaped recess;

FIG. 5 is a plan view of the device shown in FIG. 3 operating in a drawing mode;

FIG. 6 is a plan view of a surface treated by the drawing operation shown in FIG. 5;

FIG. 7 is a plan view of a multi-path device operating in a drawing mode; and

FIG. 8 is a plan view of a surface treated by the drawing operation shown in FIG. 7.

All the figures are for sake of clarity not shown in real dimensions, nor are the relations between the dimensions shown in a realistic scale.

### DETAILED DESCRIPTION OF PREFERRED EMBODIMENTS

Referring first to FIG. 1, a substrate having an upper surface 11, carries on surface 11 a fence 21 that surrounds a space filled with an environmental fluid 20. A fluid applicator comprises a first fluid container 9 that is connected via a first flow controller 7 to a first conduit 1 having a first aperture 18 arranged in proximity to the surface 11. A second fluid container 10 is connected via a second flow controller 8 to a second conduit 2 having a second aperture 19 arranged in proximity to the surface 11, and surrounding said first aperture 18. The second fluid container 10 is connected via a filter 13 to the first fluid container 9. The first fluid container 9 holds a first fluid 3 that is movable through the first conduit 1 towards the first aperture 18, and from there directable towards the surface 11. The second aperture 19 provides a flow of a second fluid 4 away from the surface 11 through the second conduit 2 into the second fluid container 10.

This arrangement allows for the creation of a fluid flow out from the first conduit 1 alongside the surface 11 and into the second conduit 2. This arrangement can be used to modify the surface 11, for instance by selecting as the first fluid 3 an acid that etches the surface where the acid impinges onto the surface 11, thereby creating an etched pattern 12. The second fluid 4 will be composed of a part of the first fluid 3 and of the environmental fluid 20.

The first flow controller 7 and the second flow controller 8 are functional to control the speed of flow through the corresponding conduits 1, 2. The filter 13 may be employed to recover the first fluid 3 from the second fluid 4. The first flow controller 7 is arranged for controlling a first flow rate and/or a first pressure p3 of the first fluid 3. The second flow controller 8 is arranged for controlling a second flow rate and/or a second pressure p4 of said second fluid 4.

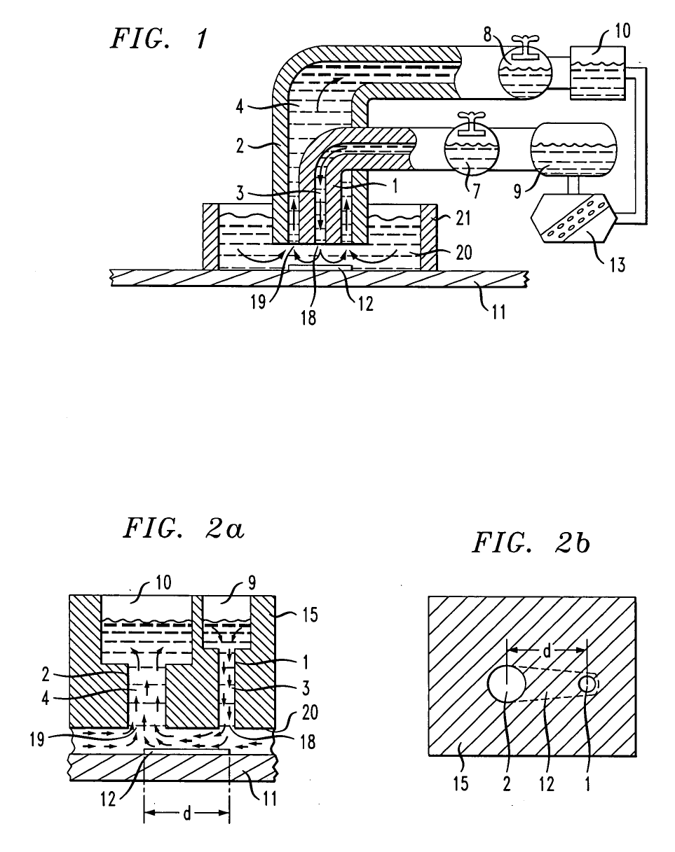

Referring next to FIG. 2a, an applicator head 15 is depicted, the applicator head 15 comprising a block of solid material having two openings, one for the first fluid container 9 and one for the second fluid container 10. The first fluid container 9 is again connected to a first conduit 1 through which a first fluid 3 is deployable to a surface 11 for creating a pattern 12 thereon. The second fluid container 10 is again connected to a second conduit 2 through which a second fluid 4 is movable into the second fluid container 10 away from the surface 11. The end of the first conduit 1 proximal to the surface 11 is the first aperture 18, while the end of the second conduit 2 proximal to the surface 11 is the second aperture 19. Both apertures 18 and 19 are arranged at a distance d from each other. Thus, the first fluid 3 when exiting from the first aperture 18 and when being drawn towards the second aperture 19, moves along an elongated flow path between the apertures 18 and 19.

The pattern that is created on the surface 11 corresponds to the form of the flow path. Hence, with this applicator head 15, patterns can be created that are not point-formed (as compared with the results of the apparatus shown in FIG. 1). The flow rate of the second fluid 4 can be controlled in a way that most, or even all, of the first fluid 3 is dragged into the second aperture 19, thereby reducing a blurring of the pattern through contact between the surface 11 and the first fluid 3 at locations outside the desired pattern area. The second aperture 19 can be designed to be larger than the first aperture 18 to enhance this effect.

FIG. 2b shows a bottom view of this applicator head 15, also depicting a possible form of the pattern 12 that may be created therewith. The applicator head 15 is combinable with the arrangement from FIG. 1, replacing the coaxial arrangement of conduits. Hence, the applicator head 15 may be modified to comprise also a first flow controller 7 and a second flow controller 8. The applicator head 15 may also be modified to not comprise the first fluid container 9 and the second fluid container 10, but instead be connectable to the first fluid container 9 and the second fluid container 10, e.g., as depicted in FIG. 1.

The first aperture 18 and the second aperture 19 of the applicator head 15 can be brought close to the surface 11 immersed in the environmental fluid 20, to be treated. The first flow controller 7 is usable to dispense the first fluid 3 through the first aperture 18 such that the first fluid 3 contacts the surface 11. Simultaneously, the second flow controller 8 can aspirate the second fluid 4 at a second flow rate equal to or larger than the first flow rate of the first flow controller 7. This can be achieved by setting the first pressure p3 lower in absolute value than the second pressure p4. The flow rates are preferably chosen such that the first fluid 3 dispensed from the first aperture 18 is aspirated back into the second aperture 19, with little or no leakage or diffusion of the first fluid 3 into the bulk of the environmental fluid 20.

It is advantageous to choose a dispense rate that results in laminar flow (such flows being typical for small dimensions). With laminar flow, there are less turbulences that could mix the dispensed first fluid 3 with the surrounding environmental fluid 20 and thus can effectively prevent leakage of the first fluid 3. The first fluid container 9 is loaded with the fluid 3 to be dispensed onto the surface 11 to be treated.

The surface 11 may be a glass surface. However, the surface 11 may have other forms. For example, the surface 11 can be flat, rough, corrugated, porous, fibrous, and/or chemically inhomogeneous.

In operation, the first aperture 18 is brought proximal to the surface 11. By tuning the first pressure in the first fluid container 9, the first fluid 3 contacts the surface 11. Active flow controllers such as external pumps, integrated pumps and valves may be provided to regulate the pressure in the fluid container 9.

The supply of the first fluid 3 can be replenished as necessary via the first fluid container 9. Such replenishing permits repetitive reuse of the device. The first fluid container 9 may be loaded and/or unloaded with the first fluid 3 from below via the first aperture 18. A lid may be provided to close the first fluid container 9. The lid may be permanently sealed so that the first fluid 3 can only be introduced via the first aperture 18. The first aperture 18 may be likewise provided with a lid to prevent evaporation, e.g., during periods of non-use. A support device having a reservoir for the first fluid 3 may be provided for filling, refilling and draining the first fluid container 9 without involving removal of the lids.

The first fluid 3 may contain treatment agents for processing a region of the surface 11. Engaging the device with the surface 11 causes exposure of the region of the surface 11 facing the first aperture 18 to the treatment agent. The treatment agent may comprise molecules. The device is therefore useful in bio-patterning applications. However, other applications are possible, such as sequential delivery of different treatments to the surface 11. Similarly, other fluid materials may be employed depending on the surface processing desired. Examples of possible fluid materials include, but are not limited to, etchants for producing localized chemical reactions on the surface 11.

In FIG. 3, an arrangement of an applicator head 15 comprising more than two apertures is depicted. In this arrangement, to a side of the flow path between the first aperture 18 and the second aperture 19 are arranged two additional apertures 21 and 22 each belonging to a third conduit 5. The third conduit 5 is here arranged to eject a third fluid 6 towards the surface 11, thereby influencing the flow of the first fluid 3, as indicated by the arrows in FIG. 3. The flow of the first fluid 3 may be narrowed under the influence of the third fluid 6. Therefore, the third fluid 6 serves as a forming fluid, giving the fluid flow of the first fluid 3 a different form and hence with it also the resulting pattern 12 on the surface 11.

At a side of the first aperture 18 distal from the second aperture 19, another additional aperture 17 may be arranged, again for ejecting the third fluid 6, using it as forming fluid to reduce the flow of the first fluid 3 that is directed away from the second aperture 19. At a side of the second aperture 19 distal from the first aperture 18, a similar aperture 16 may be arranged. All additional apertures, e.g., 16, 17, 21 and 22, that belong to the third conduit 5 hence allow for the shaping of the fluid flow of the first fluid 3 towards the second aperture 19, to improve the pattern quality.

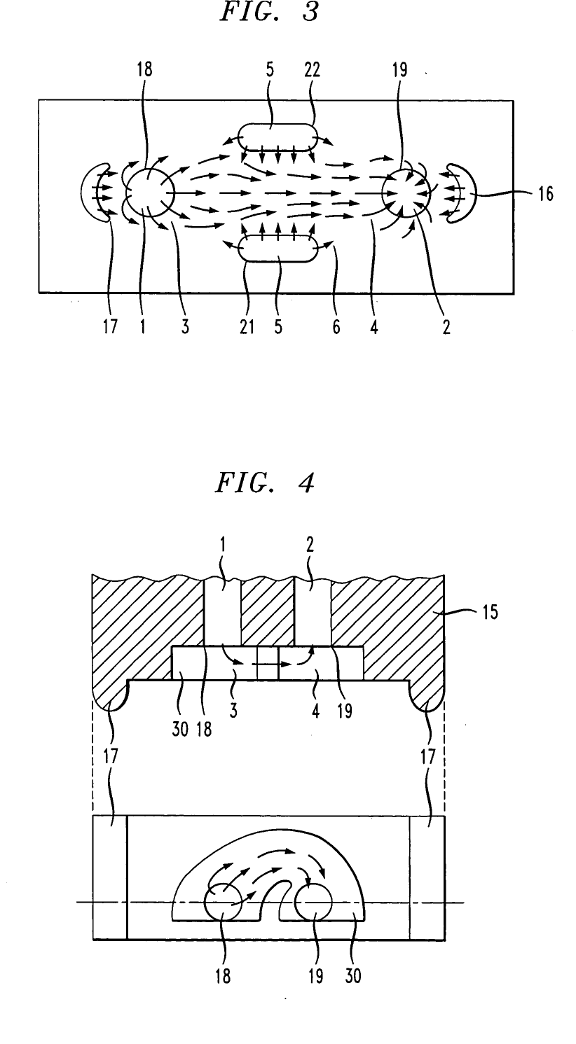

To further improve the pattern quality, the first aperture 18 and/or the second aperture 19 can be arranged in a recess 30, as depicted in FIG. 4. The recess 30 then serves as a semi-open channel to support the shape of the fluid flow of the first fluid 3. This configuration becomes particularly helpful if the recess 30 has a form that is not straight, e.g., is an arc. The first fluid 3 would follow a straight path if the recess 30 were absent, but the recess 30 channels the first fluid 3 into its form allowing the creation of a pattern that corresponds to the recess shape, e.g., the arc. The applicator head 15 may also comprise two distance elements 17 that, in the event that the applicator head 15 is brought into contact with the surface 11, determines the minimum distance between the first aperture 18 and/or the second aperture 19 and the surface 11. The geometry that is present and functional to shape the fluid flow along the flow path is thus determined and fixed. This technique allows for the precise calculation of the fluid flow and resulting pattern formation. The technique also allows for use of the applicator head 15 repetitively wherein the resulting pattern will be substantially identical on each use of the applicator head 15.

The applicator head 15 can be of unitary construction which makes it more stable, easier to manufacture and less prone to damage. The applicator head 15 may be formed from elastomeric or rigid materials. Such elastomeric or rigid materials can be shaped by microfabrication techniques such as photolithography, etching, injection molding and combinations comprising at least one of the foregoing microfabrication techniques. Alternatively, the applicator head 15 may be an assemblage of parts, such as a layered assembly. Each layer may be formed from a different material, such as, elastomer, silicon, SU-8, photoresist, thermoplastics, ceramic and metal.

There may be multiple first conduits 1 or first apertures 18 coupled to a single second aperture 19 via a common flow path. Different reactive agents may be introduced to each of the conduits for reaction within the flow path. The flow path may thus act as a reaction fluid container. Similarly, there may be multiple second apertures 19 connected to a common first aperture 18 via a common flow path. Further, there may be multiple first conduits 1 or first apertures 18 connected to multiple second apertures 19 or second conduits 2 via a common flow path.

Multiple devices, as described herein, may be integrated to form an array. Multiple different configurations of such an array are possible, involving different numbers of devices. The first fluid containers 9 and the second fluid containers 10 of such arrays may be interconnected to form a cascade. Some of the interconnected fluid containers 9 and 10 may provide reaction fluid containers in which the first fluid reacts. The product of such reactions may be analyzed in other fluid containers or on the surface 11. Such products may be used to treat or react with the surface 11.

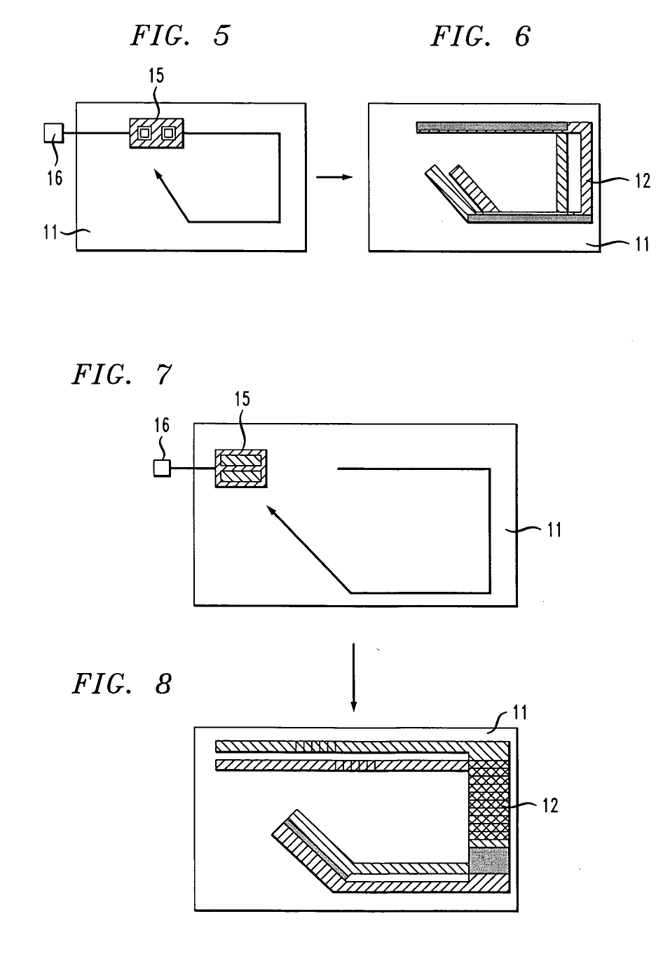

With reference to FIG. 5, the present device may be employed to trace different fluids across the surface 11, each fluid being loaded into a different fluid container of the device. The applicator head 15 is therefore coupled to a drive 16, also referred to as a manipulator. The manipulator 16 may be employed to position the applicator head 15 relative to the surface 11. With the drive 16, a series of patterns can be created one after the other. A concatenated pattern can also be created when moving the applicator head 15 during the patterning process, i.e., while the first fluid 3 is flowing out of the first aperture 18. Therefore, more complicated patterns can be created. The manipulator 16 may be manually controlled or automatically controlled via a programmable computer or similar electronic control system. The manipulator 16 may act on the applicator head 15 and/or the surface 11, providing control of (either in plane and/or out of plane) translational and/or rotational relative motions.

Referring to FIG. 6, depending the orientation and motion of the applicator head 15 relative to the surface 11, the different first fluids can be mixed in selected regions of the surface 11. Such mixing may, for example, facilitate localized reactions between the first fluids in selected regions of the surface 11. Equally the applicator head 15 may be employed to trace similar first fluids across the surface 11 in separate trails. Depending on the orientation and motion of the applicator head 15 relative to the surface 11, the trails can be separate or superimposed on each other.

A plurality of applicator heads 15 may be grouped together in an array. For example, such an array may comprise two first apertures 18 extending from separate first fluid containers 9. Each first fluid container 9 may contain the same fluid material or different fluid materials. Other arrays may comprise more than two apertures. Groups of such apertures may share a common fluid container.

Referring to FIG. 7, two or more such applicator heads 15 may be mounted in an array and the applicator head 15 may be employed trace a flow of the first fluid 3 across the surface 11. Independent control of flow rate and tracing speed permits tuning of the surface treatment applied via the applicator head 15. Such an array may also be employed to trace two fluid flows across the surface 11.

FIG. 8 depicts the resulting pattern 12 on the surface, after use of the arrangement of FIG. 7. The fluid flows may comprise the same or different fluid materials. Again, depending on the orientation and motion of the applicator head 15 relative to the surface 11, the trails of the fluid flows can be separate or superimposed on each other. Independent control of the tracing speed and flow rate permits creation of gradients in, for example, adsorbed molecules on the surface.

In an exemplary embodiment, the flow path has the dimensions of about 100 micrometers long and about 100 micrometers wide. Likewise, the first apertures 18 may be about 100 micrometers wide. The recess 30 may be between about one to about ten micrometers deep. The volumes of the fluid containers 9 and 10 may be about 500 nanoliters each. However, it is to be appreciated that the dimensions provided are merely exemplary and that different dimensions are possible.

Given the present techniques, including the present applicator head 15, it is possible to locally transport the first fluid 3 from a reservoir, i.e., the first fluid container 9, to the surface 11, and confine the first fluid 3 without requiring a physical seal and without requiring a surface free-energy confinement. Applicator head 15 can be used in different fluidic environments, e.g., the surface 11 being immersed in the environmental fluid which can be a liquid, a gas or a mixture thereof. Thus, it is possible to use non-sealing materials such as silicon to define the discharge aperture 18, without optimizing the wettability of the apertures 18 and 19 and the applicator head 15.

The dispensed first fluid 3 is recoupable, e.g., can be reused. First fluid 3 prevents contaminating or damaging the treated surface 11 by a physical contact. The flow produced by the applicator head 15 can prevent depletion of material that can otherwise occur at these small scales. The localization of the surface treatment may go down to areas of a few micrometers and possibly even lower. This device permits the creation of arrays of discharge/aspiration apertures at high density. When the applicator head 15 is drawn over a surface, it can produce smooth lines, which are smoother than inkjet patterns, and potentially smaller than inkjet lines due to the fact that the first fluid 3 does not spread significantly upon contacting the surface and because there is not a large volume that dries.

If a flow is applied in conjunction with sliding, the concentration of the deposited material can be continuously varied, such as to produce gradients. Applicator head 15 can be used for additive or subtractive (aspirator) patterning of the surface 11. If a series of applicator heads 15 are drawn, one behind the other, each discharge aperture, e.g., first aperture 18, can contain a “chain-reaction” reagent. In another application, several discharge apertures can be combined with a single aspirator, i.e., second aperture 19, allowing for the performance of complex processes on a region of a surface. For example, the several discharge apertures may contain the four nucleotide bases present in DNA which could be delivered in sequence, or the several discharge apertures may contain two components that can react together, which could for instance be used for joining, e.g., gluing, parts together. Potential applications of the present techniques, include, but are not limited to, patterning of organic materials, patterning of biomaterials, locally exposing a sub-population of fragile cells to a specific chemical treatment, exposing locally a sub-population of beads to a specific chemical treatment and drawing lines on surfaces in solution.

Fluid dispensed from the applicator head 15 is confined in a volume defined by fluid flow. A physical seal between the applicator head 15 and the surface, that is, the surface to be contacted by the fluid, is not needed.

Applicator heads, such as applicator head 15, are useful in the application of surface treatments in a range of fields, including, but not limited to, microelectronics, optics, biology, biochemistry and biotechnology. The present techniques also extend to an array of such applicator heads 15.

There may be a feedback system for measuring pressure within such a network, for example at the apertures 18 and 19 and/or fluid containers 9 and 10. Alternatively, there may be provided feedback based on the volume of fluid pumped. The feedback may facilitate control of the flow of the first fluid and avoid undesirable spreading of the first fluid on the surface. There may be a plurality of fluid containers, each coupled to an aperture, where the pressure is controlled in each fluid container, either in parallel or individually. Further, there may be one or more valves that control the flow for each fluid container in parallel or individually.

The fluid container may apply a pressure for retaining the fluid when the aperture is remote from the surface. The fluid container may comprise a capillary network for applying pressure to the fluid. The capillary network may comprise at least one of a plurality of parallel capillary members, a mesh, a porous material and a fibrous material. There may be a plurality of fluid containers each coupled to an aperture. The pressures may be such that the fluid is drawn towards the fluid containers in response to withdrawal of the aperture from the surface. There may be a plurality of first and second fluid containers, each coupled to the aperture, where the pressure is controlled in each fluid container, either in parallel or individually.

According to another exemplary embodiment of the present invention, a method for applying a fluid to a surface is provided. The method comprises the steps of locating a single aperture device proximal to the surface, supplying the fluid to the surface via the applicator head 15 and retracting the applicator head 15 from the surface.

Applicator heads, such as applicator head 15, embodying the present invention may be employed to deposit biomolecules in selected regions of a surface to make bio-arrays, thus facilitating mass fabrication of bio-chips. Applicator heads 15 embodying the present invention can be equally employed in subjecting selected areas of a surface to other processes, including, but not limited to, processes for repairing pattern defects on a surface, etching specific areas of a surface, depositing metal on a surface, localizing an electrochemical reactions on a surface, depositing catalytic particles for electroless deposition of metals, deposition glass or latex beads or other particles on a surface; passivating specific areas of a surface, patterning proteins, DNA, cells, or other biological entities on a surface, making assays and staining cells.

Applicator head 15 comprises a dual conduit system. The apertures 18 and 19 of the conduits 1 and 2 are disposed at a distance d from another, that is preferably larger than the diameter of the apertures 18 and 19 themselves. The first fluid 3 that is delivered from the delivery aperture 18 travels along the distance d and is then drawn up into the second aperture 19. The device hence works as a dynamic fluid delivery system, in that the first fluid 3 is always in motion to confine its spreading into the environmental fluid 20. Due to the constant flow of the first fluid 3, the applicator head 15 can be moved over the surface 11 also during the application of the first fluid 3. The major part of the first fluid 3 that is expelled from the first aperture 18 onto the substrate surface 11 is drawn into the second aperture 19. In the ideal case, the portion of the first fluid that is drawn into the second aperture 19 is more than 90 percent of the expelled amount of the first fluid 3. The distance d between the apertures 18 and 19 determines the size of the resulting pattern 12 on the surface 11. In an application where the applicator head 15 is not moved during the fluid application, the pattern 12 has hence a length that substantially corresponds to the distance d. More precisely, if the distance is measured between the centers of the apertures, the length of the pattern 12 in that direction corresponds to the distance d plus the distance between the centers and the distal aperture rim of each of the apertures 18 and 19. In a case in which the applicator head 15 is moved and used, for example, like a writing implement in a “pencil-like” fashion, the distance d determines the width of the line if moved orthogonally to the line connecting the two apertures 18 and 19.

The expulsion of the first fluid 3 from the first aperture 18 occurs synchronously to the sucking of the second fluid 4 into the second aperture 19, in order to achieve the desired precision of the resulting pattern 12. To ensure that the fluid flow of the second fluid 4 occurs at the same time as the fluid flow of the first fluid 3, the flow controllers 7 and 8 can be coupled to respond to a single switch-on signal, or be mechanically coupled. The applicator head 15 is ideally operated to draw as much as possible, if not all, of the expelled first fluid 3 into the second aperture 19.

The device can also be operated to manipulate a particle, such as a cell, a bead, a molecule or a nanodevice. Therefore, the applicator head 15 is located near the particle that resides on the surface 11 in the environmental fluid 20. The first fluid 3 is then moved towards the surface 11, whereby the particle is removed from the surface 11 and drawn into the second conduit 2. The applicator head 15 can thereafter be removed from that position. The particle can in the same, or a modified form, thereafter be deposited at a different location, either by moving it into the first conduit 1 and from there to the different location, or by reversing the operation of the applicator head 15 and moving the second fluid towards the surface 11.

Although illustrative embodiments of the present invention have been described herein, it is to be understood that the invention is not limited to those precise embodiments, and that various other changes and modifications may be made by one skilled in the art without departing from the scope or spirit of the invention.

1. A device for applying a fluid to a surface, the device comprising a first conduit for directing a flow of a first fluid towards the surface and a second conduit for directing a flow of a second fluid away from the surface, the first conduit being arranged relative to the second conduit such that in operation of the device the second fluid comprises substantially the first fluid, and wherein the first conduit comprises a first aperture and the second conduit comprises a second aperture, the first aperture arranged at a distance from the second aperture.

2. The device of claim 1, wherein the distance between the first aperture and the second aperture corresponds to a pattern being produced on the surface.

3. The device of claim 1, further comprising one or more containers for at least one of the first fluid and the second fluid.

4. The device of claim 1, further comprising a first flow controller for controlling at least one of a flow rate and a pressure of the first fluid.

5. The device of claim 1, further comprising a second flow controller for controlling at least one of a flow rate and a pressure of the second fluid.

6. The device of claim 1, wherein at least one of a flow rate and a pressure of the first fluid and at least one of a flow rate and a pressure of the second fluid are configured such that the first fluid is drawn towards the second aperture.

7. The device of claim 1, further comprising a filter for regenerating the first fluid from the second fluid.

8. The device of claim 1, wherein the first conduit and the second conduit are arranged at an applicator head.

9. The device of claim 8, further comprising a drive for moving the applicator head relative to the surface.

10. The device of claim 8, wherein at least one of the first aperture and the second aperture is arranged in a recess of the applicator head.

11. The device of claim 8, wherein at least one of the first aperture and the second aperture is arranged in a recess of the applicator head, the recess serving as a flow path.

12. The device of claim 8, wherein at least one of the first aperture and the second aperture is arranged in a recess of the applicator head, the recess serving as a curved flow path.

13. The device of claim 1, wherein the first aperture and the second aperture are arranged at a substantially identical distance from the surface.

14. The device of claim 1, further comprising a third conduit for directing a flow of a third fluid to influence a flow direction of the first fluid.

15. The device of claim 1, further comprising a distance element for determining a distance between the first aperture, the second aperture and the surface.

16. The device of claim 1, further comprising a distance element in contact with the surface to keep substantially constant a distance between the first aperture, the second aperture and the surface.

17. The device of claim 1, comprising a unitary construction.

18. An array of devices for applying a fluid to a surface, at least one of the devices comprising:
a first conduit for directing a flow of a first fluid towards the surface and a second conduit for directing a flow of a second fluid away from the surface, the first conduit being arranged relative to the second conduit such that in operation of the device the second fluid comprises substantially the first fluid, and wherein the first conduit comprises a first aperture and the second conduit comprises a second aperture, the first aperture arranged at a distance from the second aperture.

19. A method for applying a first fluid to a surface, the method comprising the steps of:
locating a device for applying a fluid to a surface proximal to the surface, the device comprising:
a first conduit for directing a flow of the first fluid towards the surface and a second conduit for directing a flow of a second fluid away from the surface, the first conduit being arranged relative to the second conduit such that in operation of the device the second fluid comprises substantially the first fluid, and wherein the first conduit comprises a first aperture and the second conduit comprises a second aperture, the first aperture arranged at a distance from the second aperture; and
applying the first fluid to the surface via the device.

20. The method of claim 19, further comprising the step of retracting the device from the surface.

21. The method of claim 19, wherein the step of applying further comprises the step of varying the flow of the first fluid.

22. The method of claim 19, further comprising the step of moving the device relative to the surface with the first fluid contacting the surface.

23. The method of claim 22, wherein the step of moving further comprises the step of orienting the device relative to the surface such that traces of the first fluid produced as the device is moved relative to the surface remain separate.

24. The method of claim 22, wherein the step of moving further comprises the step of orienting the device relative to the surface such that traces of the first fluid produced as the device is moved relative to the surface overlap.

25. A method for applying a first fluid to a surface, the method comprising the steps of:
locating an array of devices for applying a fluid to a surface, at least one of the devices comprising:
a first conduit for directing a flow of the first fluid towards the surface and a second conduit for directing a flow of a second fluid away from the surface, the first conduit being arranged relative to the second conduit such that in operation of the device the second fluid comprises substantially the first fluid, and wherein the first conduit comprises a first aperture and the second conduit comprises a second aperture, the first aperture arranged at a distance from the second aperture;
applying the first fluid to the surface via at least one device of the array of devices along a flow path;
moving the array of devices relative to the surface with the first fluid contacting the surface; and
retracting the array of devices from the surface.

26. The method of claim 25, wherein the step of applying further comprises the step of varying the flow of the first fluid in at least one device of the array of devices.

27. A method for manipulating a particle residing on a surface, the method comprising the steps of:
locating a device for applying a fluid near the particle, the device comprising:
a first conduit for directing a flow of the first fluid towards the surface and a second conduit for directing a flow of a second fluid away from the surface, the first conduit being arranged relative to the second conduit such that in operation of the device the second fluid comprises substantially the first fluid, and wherein the first conduit comprises a first aperture and the second conduit comprises a second aperture, the first aperture arranged at a distance from the second aperture; and
operating the device to remove the particle from the surface via the first fluid.

28. The method of claim 27, wherein the particle is present in an environmental fluid.
